(19) United States
(12) Patent Application Publication
(10) Pub. No.: US 2002/0133457 A1
(43) Pub. Date: Sep. 19, 2002

(54) Apparatus and method for prepaid charging of wireless packet data services

(76) Inventors: Charles Althoff Gerlach, St. Charles, IL (US); James M. Grinn, Plano, IL (US); Subhasis Laha, Aurora, IL (US); Somasundaram Velayutham, Aurora, IL (US); Joe Ping Zhou, Naperville, IL (US)

Correspondence Address: Docket Administrator (Rm. 3C-512),, Lucent Technologies Inc.,, 600 Mountain Avenue, P.O. Box 636, Murray Hill, NJ, 07974-0636, US

(21) Appl. No.: 09/773,039

(22) Filed: Jan. 31, 2001

(51) Int. Cl. G06F 17/60

(52) U.S. Cl. 705/39; 705/40

(57) ABSTRACT

The present invention provides apparatus and methods for billing a packet switched call utilizing a prepaid account in which a prepaid packet note (PPN) monitors a subscriber's usage during the call. The PPN is logically associated with a wireless packet serving node (WPSN) that executes call processing that is associated with the call. Moreover, the present invention provides apparatus and method for enabling the subscriber to replenish the subscriber's prepaid account.

The disclosure describes exemplary embodiments for implementing the present invention with code division multiple access (CDMA), time division multiple access (TDMA), global system for mobile communications (GSM), and universal mobile telecommunications system (UMTS) wireless technologies. Additionally, the disclosure provides an exemplary embodiment in which the subscriber can replenish the subscriber's prepaid account through a signal processor such as a website or a telephone processing unit.

### FIELD OF THE INVENTION

The present invention provides apparatus and methods for prepaid wireless packet data services.

### BACKGROUND OF THE INVENTION

Wireless communications has become an integral part of many people's lives, both for both business and personal reasons. Just as there is a diversity of wireless services ranging from voice to data services, there is spectrum of billing systems that satisfy the varying needs of different wireless subscribers. As an example, a wireless subscriber can sign a service agreement in which the wireless subscriber pays a monthly charge for a designated number of minutes of use. If the wireless subscriber does not use all the designated minutes of use, the wireless subscriber still pays the same monthly charge. In other words, the wireless subscriber is guaranteeing a minimum number of minutes. On the other hand, if the wireless subscriber uses more than the designated number of minutes, the wireless subscriber pays an additional charge. It therefore behooves the wireless subscriber to estimate the actual number of minutes of use to be as close to the actual monthly usage as possible. Even if the wireless subscriber can accurately guess the actual usage, the actual usage can vary from month to another. Additionally, the service provider can process billing information about the wireless subscriber's calls at a time subsequent to the call activity. The billing plan described heretofore is referred as a “post-call billing plan.”

“Prepaid billing” is an alternative billing plan to the “post-call billing plan.” With “prepaid billing”, the wireless subscriber typically pays in advance for a given number of minutes of use. The wireless subscriber's prepaid account is debited for the actual usage. The service provider can utilize one of several methods for determining usage. First, the service provider can process call detail records (CDR) after call activity as with the “post-call billing plan.” A second method is to monitor each call and to deduct the call's time duration from the purchased time. The second method is usually preferred over the first method. With the first method, the wireless subscriber can exceed usage as specified by the purchased time because CDR's are processed after call activity. The wireless subscriber pays for the actual usage, although the rate per minute is typically higher for the “prepaid billing plan” in comparison with the “post-call billing plan.”

Many wireless subscribers have found that the “prepaid billing plan” to be very appealing, thus increasing revenues for wireless service providers. In fact, some wireless service providers have a customer base in which about fifty percent of the wireless subscribers choose the “prepaid billing plan.” Moreover, service providers enjoy the benefit of minimizing billing efforts by collecting payment in advance.

Currently, wireless communications systems (as typified by second generation wireless systems, called “2G” systems) implement wireless services using a circuit switched call model. In the circuit switched call model, a physical path for wireless communications between the wireless device (e.g. a mobile telephone, a fixed wireless telephone, a wireless palm pilot, a wireless data terminal, or a computer having wireless access) and the telephone network is set up (and billed-for) for a given duration of time. With the prior art, the “prepaid billing plan” is predicated on the assumption that the information rate (e.g. bits per second or frames per second) is constant. This assumption is accurate for circuit switched calls such as traditional voice calls.

Wireless communications systems, however, are moving to third generation (“3G”) wireless systems in which call processing is migrating to a packet switched call model from a circuit switched call model. The prior art for “prepaid billing” is not germane to the characteristics of packetized wireless communications. Rather than information being transferred at a constant rate, information may be transferred at a variable rate (possibly having a large variance) with the transmission of packets. With the increasing deployment of packetized wireless communications, billing a call in accordance with the duration of the call may not be a good metric with respect to the value of service as perceived by the wireless subscriber.

The application of the “prepaid billing plan” is relevant and important to the problem of measuring usage for packetized services. If packetized services are to be widely accepted by wireless subscribers, the wireless subscriber must be assured that the billing structure fairly measures the amount of actual benefit provided to the wireless subscriber. The “prepaid billing plan” helps address this important need for the wireless communications industry.

### SUMMARY OF THE INVENTION

The present invention provides apparatus and methods to enable a subscriber of a wireless packetized data service to be billed though a prepaid account in which the subscriber's usage is monitored during a packet switched call. Also, the present invention provides apparatus and method that allows the subscriber to replenish the prepaid account through a communications device. A wireless telecommunications system supports prepaid charging with a prepaid packet node (PPN) that is associated with a wireless packet serving node (WPSN) and an accounting processor that stores information about the subscriber's prepaid account. The WPSN establishes and maintains call processing during the packet switched call as well as tracks and counts packetized data usage. The combination of the WPSN and the PPN is referred as a WPSN-PPN. The accounting processor provides a limit of usage to the PPN when queried by the PPN. If a balance of the subscriber's account is not sufficient, the accounting processor can instruct the WPSN-PPN to reject the call setup attempt. During the call, the PPN monitors the subscriber's usage, which can be a time duration, a number of packets, or a predetermined amount of conveyed information. When the associated packet switched call ends or a handover occurs during the call, the PPN provides the accounting processor with the subscriber's usage during the call. The accounting processor adjusts the subscriber's account accordingly. If the subscriber exceeds a maximum usage during the call, the PPN ends the call through the WPSN.

The disclosure describes an exemplary embodiment for a wireless telecommunications system that supports prepaid billing for Code Division Multiple Access (CDMA) wireless technology. The exemplary embodiment provides an architecture as well as illustrative message scenarios for call setup, call release, and handover. The disclosure further applies the present invention to exemplary embodiments supporting Time Division Multiple Access (TDMA), Global System for Mobile Communications (GSM), and Universal Mobile Telecommunications System (UMTS) wireless technologies. The disclosure also describes an exemplary embodiment for replenishing a subscriber's prepaid account by the subscriber accessing a website or a telephone processing unit through the subscriber's wireless device or other communications device.

### BRIEF DESCRIPTION OF THE DRAWINGS

FIG. 1 illustrates a CDMA wireless telecommunications system supporting packet data services according to the current art;

FIG. 2 shows a message scenario for call setup and call release in a wireless telecommunications system in FIG. 1 according to the current art;

FIG. 3 illustrates a wireless telecommunications system that supports prepaid billing of packet data services in which a subscriber can roam from a home service area to a visited service area according to the present invention;

FIG. 4 shows a wireless telecommunications system that supports prepaid billing of packet data services in which a subscriber can roam from a first visited service area to a second visited service area according to the present invention;

FIG. 5 is a message scenario for a call setup and a call release with the wireless telecommunications system shown in FIG. 4 that supports a packet data service according to the present invention;

FIG. 6 is a message scenario in which a packet switched call is released by the wireless telecommunications system in FIG. 4 because a balance of a prepaid account is less than a minimum value according to the present invention;

FIG. 7 is a message scenario for an access failure because the wireless telecommunications system in FIG. 4 determines that the balance of the prepaid account is insufficient in accordance with the present invention;

FIG. 8 is a message scenario for an access failure with an associated warning message to a wireless device because the wireless telecommunications system in FIG. 4 determines that the balance of the prepaid account is insufficient in accordance with the present invention;

FIG. 9 is a message scenario for a handover in which a wireless device is subsequently served by a second PDSN of the wireless telecommunications system in FIG. 4 according to the present invention;

FIG. 10 illustrates a GSM or a TDMA wireless telecommunications system that supports GPRS and supports prepaid billing of packet data services in which a subscriber can roam from a first BSC to a second BSC controller in accordance with the present invention;

FIG. 11 illustrates a UMTS wireless telecommunications system that supports prepaid billing of packet data services in which a subscriber can roam from a first UTRAN to a second UTRAN according to the present invention;

FIG. 12 is a flow diagram for initiating a packet switched call in which a subscriber has a prepaid account for wireless telecommunications systems in FIGS. 3, 4, 10, and 11;

FIG. 13 is a flow diagram for maintaining a packet switched call in which a subscriber has a prepaid account for wireless telecommunications systems in FIGS. 3, 4, 10, and 11;

FIG. 14 illustrates a wireless prepaid system enabling a subscriber to replenish the subscriber's prepaid account according to the present invention; and

FIG. 15 shows a set of visual screens that can be displayed at a wireless device and that are generated by a prepaid website according to the present invention.

### DETAILED DESCRIPTION

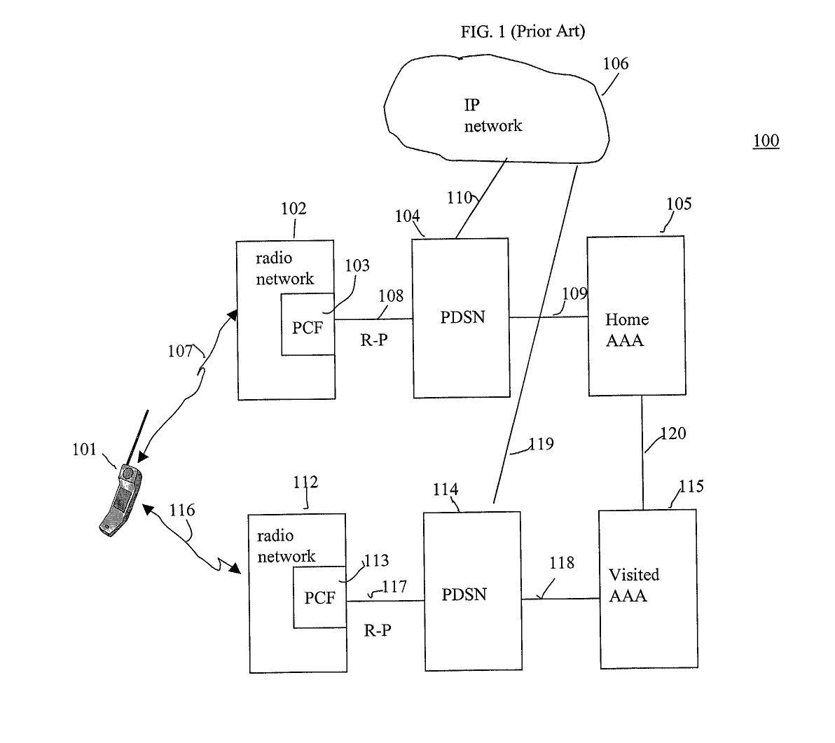

FIG. 1 illustrates CDMA wireless telecommunications system 100 that supports a packet switched call according to the current art. Wireless device 101 and wireless telecommunications system interact in accordance with TIA/EIA/IS-95 (Mobile Station-Base Station Compatibility Standard for Dual-Mode Wideband Spread Spectrum Cellular System) or TIA IS-2000 (CDMA2000 Standards for Spread Spectrum Systems) and with TIA/ELA/IS-835 (Wireless IP Network Standard). Wireless device 101 may be a mobile telephone, a fixed wireless telephone, a wireless palm pilot, a wireless data terminal, or a computer having wireless access. While in its home service area, wireless device 101 communicates over radio link 107, typically utilizing point to point protocol (PPP), and is served by radio network 102. Packet Control Function (PCF) 103 processes packet data messages over radio link 107 and sends the packet data messages on radio-packet (R-P) interface 108. R-P interface 108 connects PCF 103 with packet data service node (PDSN) 104. PCF 103 supports a relay function between wireless device 101 and PDSN 104 and a buffering function to handle rate mismatches and temporary radio outages on radio link 107. PDSN 104 provides the call processing of the packet switched call and connects to Internet protocol (IP) network 106 through network interface 110. PDSN 104 also tracks and counts a packetized data usage. Thus, the call path comprises radio link 107, radio network 102, PCF 103, R-P interface 108, PDSN 104, network interface 110, and IP network 106. PDSN 104 can serve a plurality of radio networks with corresponding PCF's by establishing separate connections to PDSN 104 on corresponding R-P interfaces.

PDSN 104 interacts with home accounting, authentication, and authorization center (AAA) 105 to verify that wireless device 101 is authorized service and to verify the identity of wireless device 101 before establishing the packet switched call. When the packet switched call is ended (released), account information is sent from PDSN 104 to home AAA 105. The account information contains usage data (e.g. time or octets of information) from which billing is subsequently generated (“post-call billing”).

The prior art supports various approaches for establishing IP data connections, including simple IP and mobile IP. Mobile IP can maintain the IP address of wireless device 101 as wireless device 101 moves from the home service area that is served by radio network 102 and PDSN 104 to a visited service area that is served by radio network 112 and PDSN 114 through radio link 116. Thus with mobile IP, the packet switched call can be maintained if a handover occurs from radio network 102 to radio network 112.

In order to support the packet-switched call when a handover is initiated, the identity of wireless device 101 is verified by home AAA 105 through visited AAA 115, interface 118, and interface 120. If wireless device 101 is successfully verified, the call path is reconfigured. In such a case, the call path comprises radio link 116, radio network 112, PCF 113, R-P interface 117, PDSN 114, and interface 119 to IP network 106.

When the packet switched call is either ended or is handed off from radio network 112, accounting information is sent from PDSN 114 to home AAA 105 through visited AAA 115 so that billing can be subsequently processed.

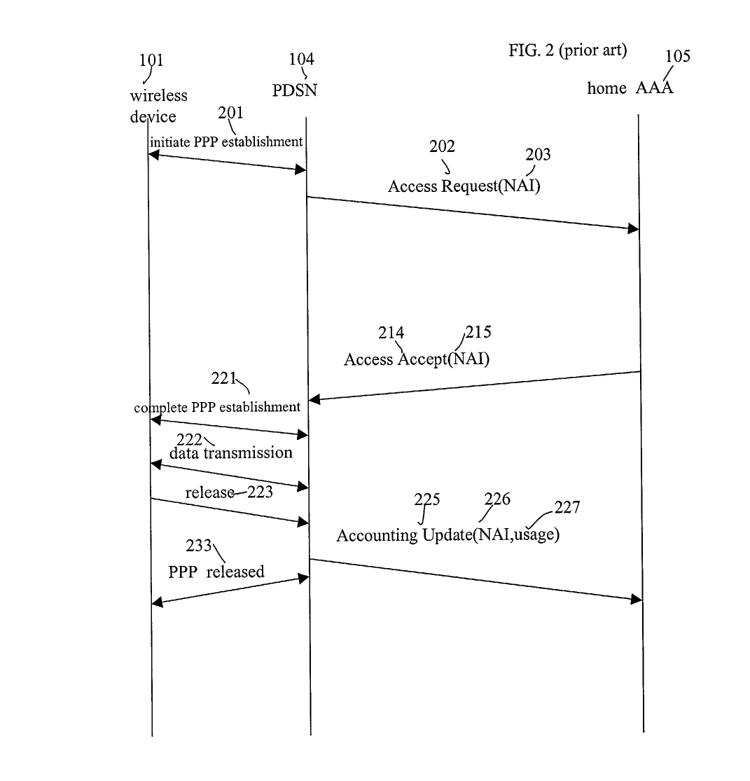

FIG. 2 illustrates a message scenario for a call setup and a call release for the wireless telecommunications system 100 of FIG. 1, in accordance with prior art. Wireless device 101 requests a packet data service, and a connection using point to point protocol (PPP) by initiating PPP establishment procedure 201. In response to PDSN 104 detecting the initiation of the PPP connection, PDSN 104 sends access request message 202 to home AAA 105. Access request message is specified in IETF RFC 2865 (Remote Authentication Dial In User Service—RADIUS). Access request message 202 comprises a network access identifier (NA) attribute 203 that identifies wireless device 101.

If wireless device 101 is successfully authorized and authenticated, home AAA 105 returns access accept message 214 (as specified by RFC 2865) to PDSN 104. PDSN 104 consequently completes PPP establishment 221, resulting in data transmission 222 between wireless device 101 and PDSN 104. The packet switched call is connected to IP network 106.

In order to end the packet data service, wireless device 101 subsequently requests a call release by sending release message 223 to PDSN 104. PDSN 104 consequently releases the PPP connection 233. PDSN 104 subsequently sends accounting information, which comprises the subscriber's usage, in accounting update message 225 to home AAA 105. Message 225 comprises NAI attribute 226 and usage attribute 227. Accounting update message 225 is advantageously implemented as an Accounting-Request message as specified in IETF RFC 2866 (RADIUS Accounting). Usage attribute 227 measures a usage associated with the packet switched call and may measure the time of the data session (e.g. attribute Acct-Session-Time) or the number of information octets sent to (attribute Acct-Output-Octets) and received from (attribute Acct-Input-Octets) wireless device 101, which are processed only after the call is completed. Accounting update message is specified in IETF RFC 2866 (RADIUS Accounting). Billing can be subsequently processed for the packet switched call. The connection on radio link 107 is released with PPP released procedure 233.

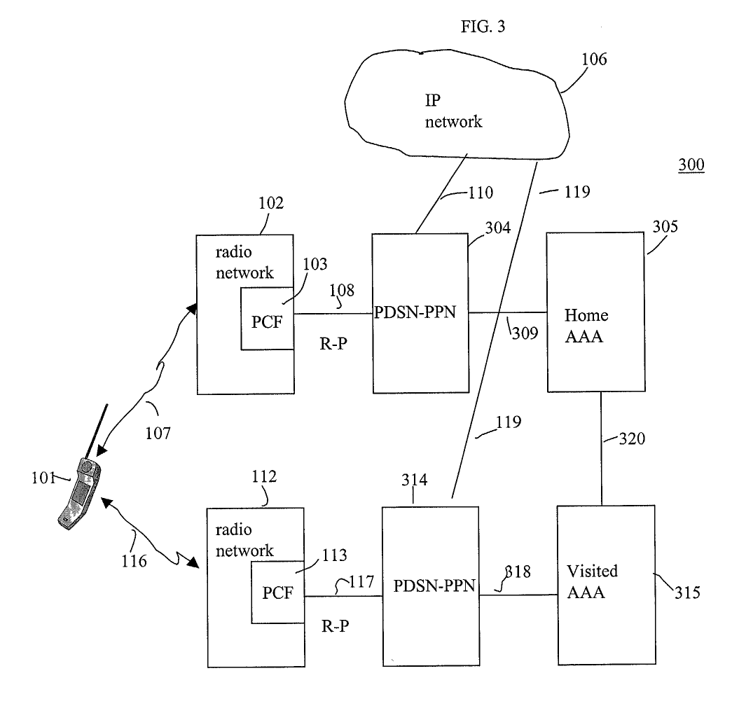

FIG. 3 shows a wireless telecommunications system that supports prepaid billing of packet data services in which a subscriber can roam from a home service area to a visited service area, in accordance with the present invention. While in its home service area, wireless device 101 interacts with radio network 102 over radio link 107 in accordance with TIA/EIA/IS-95 or TIA IS-2000 Standards, although one skilled in the art appreciates that the present invention is applicable to other radio technologies.

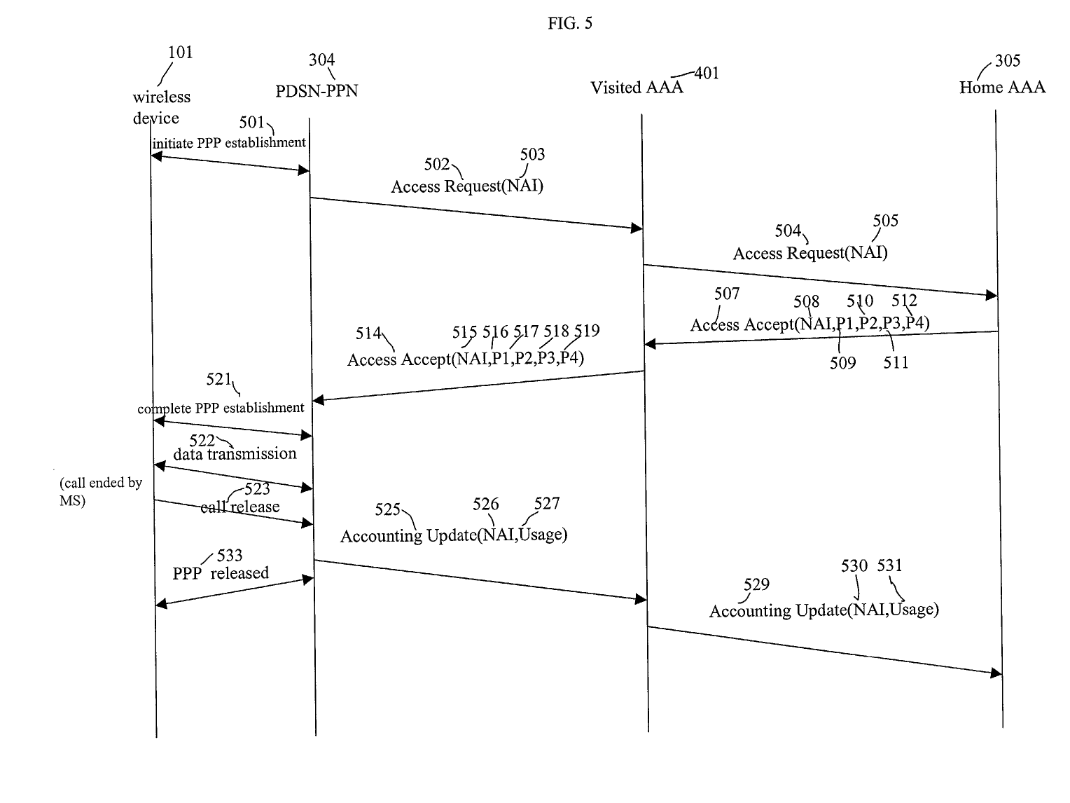

A data connection, typically utilizing PPP, is established with PCF 103 and the associated packet data is sent to packet data service node-prepaid packet node (PDSN-PPN) 304 over R-P interface 108. PDSN-PPN 304 provides call processing for a packet switched call. Additionally, PDSN-PPN 304 monitors a measured usage associated with the packet data call and executes appropriate actions if the measured usage exceeds a limit that is associated with the subscriber's prepaid account. (The discussions associated with FIGS. 5, 6, 7, 8, and 9 give further details about the appropriate actions executed by PDSN-PPN 304.)

PDSN-PPN 304 provides the functionality of PDSN 104, as shown in FIG. 1, and the additional functionality of supervising a packet switched call that is associated with prepaid billing. The functionality of prepaid billing is logically associated with the prepaid packet node (PPN) component of PDSN-PPN 304. In the exemplary embodiment, the PDSN component and the PPN component are co-located on the same platform as PDSN-PPN 304. However, one skilled in the art appreciates that the PDSN component can be physically separated even though the PDSN and the PPN components are logically associated with each other.

PDSN-PPN 304 interacts with home accounting, authentication, and authorization (AAA) center 305 to verify that wireless device 101 is authorized service and to verify the identity of wireless device 101 before establishing the packet switched call. If the subscriber has a prepaid account, AAA 305 stores information about the subscriber's prepaid account, e.g. the remaining usage in the account. AAA 305 sends appropriate information about the subscriber's prepaid account to PDSN-PPN 304, enabling PDSN-PPN 304 to supervise the prepaid status of the account during the call.

After a successful validation of wireless device 101, PDSN-PPN 304 establishes a data connection to IP network 106 through network interface 110. Thus, the call path comprises radio link 107, radio network 102, PCF 103, R-P interface 108, PDSN-PPN 304, and network interface 110 to IP network 106.

By supporting mobile IP (as with wireless telecommunications system 100 shown in FIG. 1), wireless telecommunications system 300 can maintain the IP address of wireless device 101 as wireless device 101 moves from a service area served by radio network 102 and PDSN-PPN 304 to a service area served by radio network 112 and PDSN-PPN 314. (If a handover does not require a change in the PDSN-PPN, the IP address need not change, and thus simple IP is adequate to complete the handover.) In order to support the packet switched call if a handover is initiated, the identity of wireless device 101 is verified by home AAA 305 through visited AAA 315, interface 318, and interface 320. If wireless device 101 is successfully verified, a limit of usage is sent from home AAA 305 through visited AAA 315 to PDSN-PPN 314, resulting in a reconfiguration of the call path. The call path then comprises radio link 116, radio network 112, PCF 113, R-P interface 117, PDSN-PPN 314, and interface 119 to IP network 106.

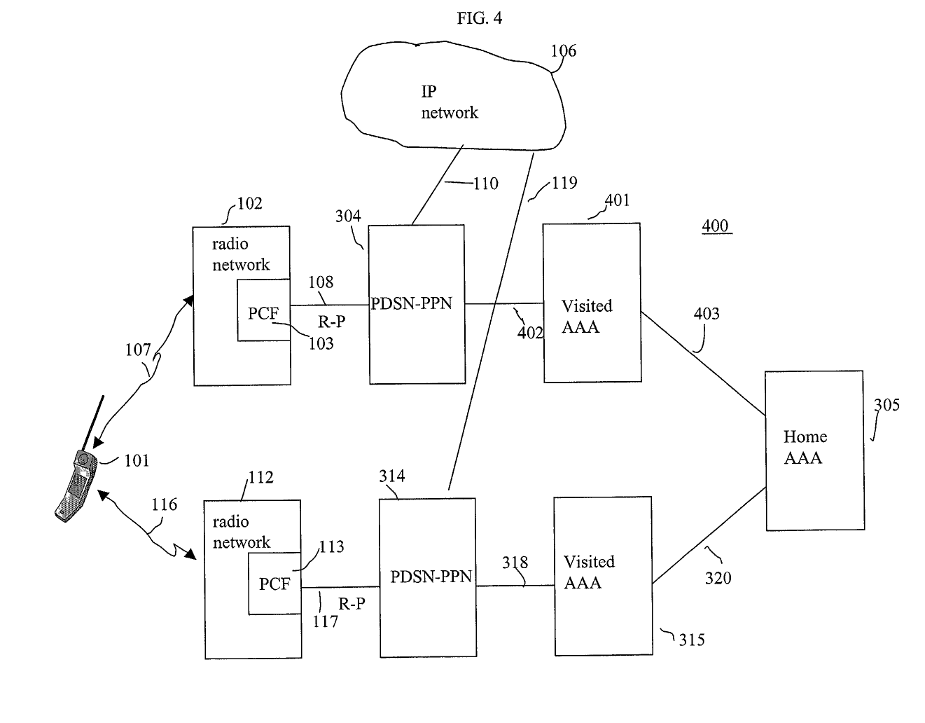

FIG. 4 illustrates a wireless telecommunications system that supports prepaid billing of packet data services in which a subscriber can roam from a first visited service area to a second visited service area. In FIG. 4 a packet switched call is established when wireless device 101 is located in a visited service area, while in FIG. 3 a packet switched call is established when wireless device 101 is located in a home service area. In FIG. 4 PDSN-PPN 304 interacts with home AAA 305 through visited AAA 401, interface 402, and interface 403 to verify that wireless device 101 is authorized service and to verify the identity of wireless device 101 before establishing the call.

FIG. 5 is a message scenario for a call setup and a call release with telecommunications system 400 shown in FIG. 4. Wireless device 101 requests for a packet data service by initiating PPP establishment 501 with PDSN-PPN 304. PDSN-PPN 304 sends access request message 502 comprising NAI attribute 503 that identifies wireless device 101. Because wireless device 101 is roaming, access request 502 is sent to visited AAA 401, and consequently access request message 504 is forwarded to home AAA 305.

Home AAA 305 determines that wireless device 101 is valid and that the subscriber has a valid prepaid account. Consequently, home AAA 305 returns access accept message 507 to visited AAA 401. Access accept message 507 comprises attributes that are relevant to prepaid billing, including Acct-Billing-Option (P1) 509, Activation Status (P2) 510, Acct-Usage-Limit (P3) 511, and Acct-Meter-Unit (P4) 512. (Attributes 509, 510, 511, and 512 are not specified in IETF RFC 2865, and thus the exemplary embodiment uses corresponding proprietary attributes.) Acct-Billing-Option 509 reflects the subscriber's billing option as stored in home AAA 305. Exemplary values of attribute 509 are “post usage billing ” (corresponding to post-call billing), “wireless packet prepaid billing on the downlink” (corresponding to prepaid billing for packet data sent to wireless device 101), “wireless packet prepaid billing on the uplink ” (corresponding to packet data received from wireless device 101), and “wireless packet prepaid billing on the uplink and downlink” (corresponding to prepaid billing for packet data sent to and received from wireless device 101). Exemplary values for Activation Status 510 are “demand” (corresponding to the subscriber being able to activate prepaid billing on a per call basis), “permanent” (corresponding to prepaid billing being activated for all calls), and “null” (corresponding to prepaid billing not being authorized). Acct-Usage-Limit 511 is dependent upon an amount remaining for the subscriber when served by PDSN-PPN 304.

Protocols other than RADIUS (as specified in IETF RFC 2865 and RFC 2866 ) may be used in embodiments of the invention. One example of an alternative protocol is DIAMETER (as specified in IETF DIAMETER Base Protocol, Internet Draft, September 2000).

Home AAA 305 determines Acct-Usage-Limit 511 for the subscriber. In the exemplary embodiment, the subscriber has an amount (typically monetary in a value such as U.S. dollars) in the subscriber's prepaid account. As an example, home AAA 305 determines a balance (as indicated by Acct-Usage-Limit 511 in units of 1000 octets) by dividing the amount of the prepaid account (e.g. dollars) by a rate (e.g. units of dollars per 1000 octets of transported information). The rate reflects the costliness of the call. The rate may be dependent on one or more of the following variables: a time of day, day of week, a calling plan that is associated with the subscriber, a service location of wireless device 101, and a level of quality of service (QoS) that is associated with the subscriber.

Visited AAA 401 relays access accept message 514 with attributes 515, 516, 517, 518, and 519 to PDSN-PPN 304. PDSN-PPN 304 consequently completes PPP establishment 521 and commences data transmission 522. PDSN-PPN 304 utilizes attributes 516, 517, 518, and 519 for pursuant actions regarding the prepaid status of the call. If Acct-Billing-Option 516 and Activation Status 517 indicate that prepaid billing is applicable, PDSN-PPN 304 utilizes Acct-Usage-Limit 518 and Acct-Meter-Unit 519 for monitoring the call. With the message scenario shown in FIG. 5, the usage of the call does not exceed Acct-Usage-Limit 518 before call release 523. With call release 523, PDSN-PPN 304 sends accounting update message 525 (comprising attributes NAI 526 and usage 527) to visited AAA 401. Visited AAA 401 relays message 525 as accounting update message 529 to home AAA 305. Home AAA 305 utilizes usage attribute 531 for adjusting the prepaid account associated with wireless device 101 (assigned with NAI attribute 530). PDSN-PPN 304 removes the data connection to wireless device 101 corresponding to PPP released 533.

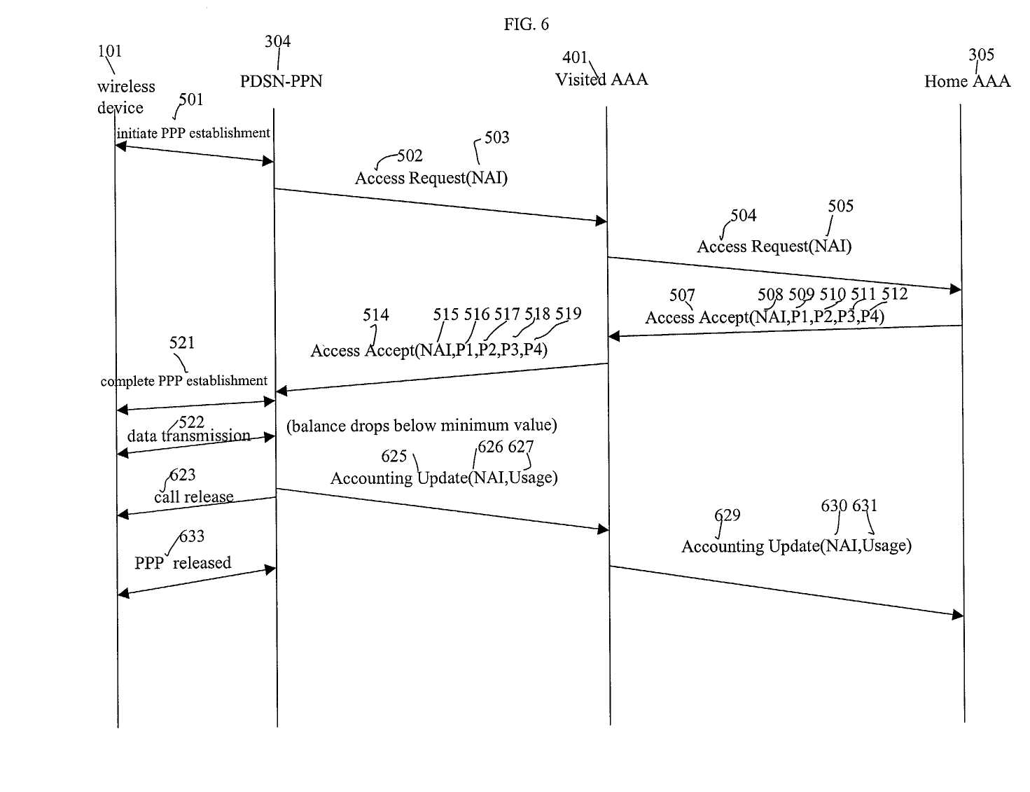

FIG. 6 is a message scenario in which a packet switched call is released by wireless telecommunications 400 because a balance of a subscriber's prepaid account is less than a minimum value. Messages 501, 502, 504, 507, 514, 521, and 522 shown in FIG. 6 correspond to messages 501, 502, 504, 507, 514, 521, and 522 shown in FIG. 5. However, in FIG. 6, PDSN-PPN 304 determines that the usage exceeds Acct-Usage-Limit 511 during the call. Thus, PDSN-PPN 304 releases the call 623 and sends accounting update message 625 with attributes 626 and 627 to visited AAA 401. Also, PPP connection 633 is released. Visited AAA 401 relays accounting update message 629 to home AAA 305. Home AAA 305 utilizes attribute 631 to adjust the prepaid account of the subscriber assigned to wireless device 101 (corresponding to NAI attribute 630).

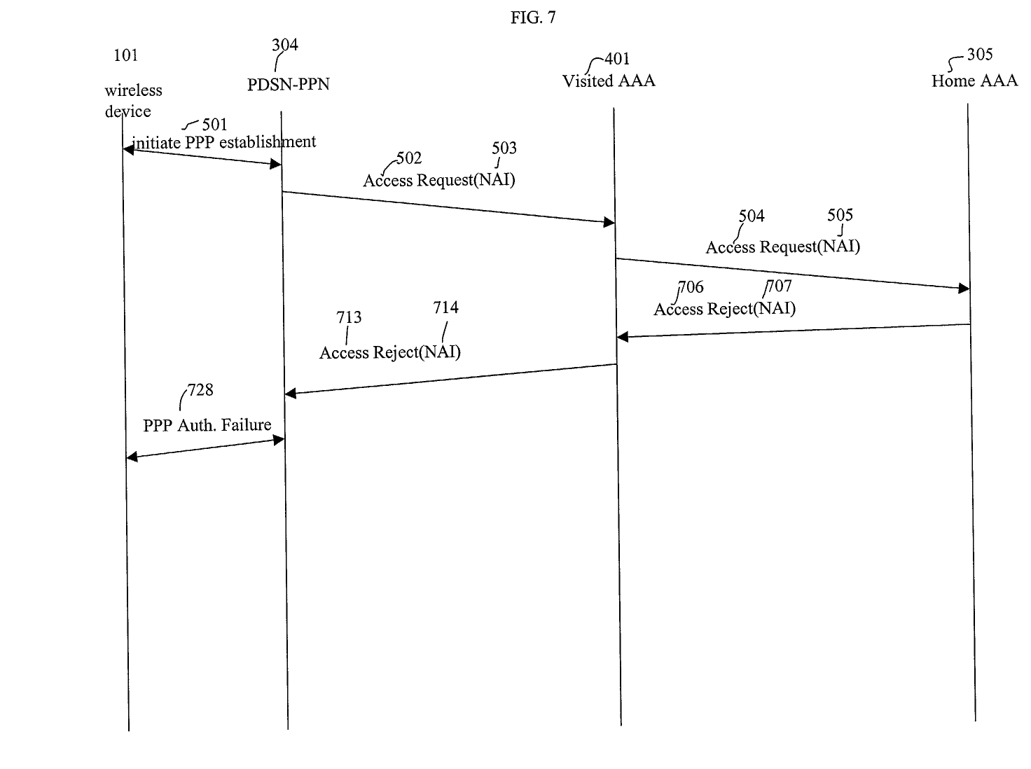

FIG. 7 is a message scenario for an access failure because wireless telecommunications system 400 determines that the balance of the prepaid account is insufficient. As in FIG. 5, messages 501, 502, and 504 correspond to messages 501, 502, and 504 in FIG. 7. However, home AAA 305 determines that the balance of the subscriber's prepaid account is insufficient to establish the packet switched call. Consequently, home AAA 305 sends access reject message 706 comprising NAI attribute 707 to visited AAA 401. In the exemplary embodiment, access reject message 706 is specified in IETF RFC 2865 (Remote Authentication Dial In User Service—RADIUS). Visited AAA 401 relays access reject message 713 comprising NAI attribute 714 to PDSN-PPN 304. Consequently, PDSN-PPN 304 sends PPP authentication failure message 728, thus ending the call attempt by wireless device 101.

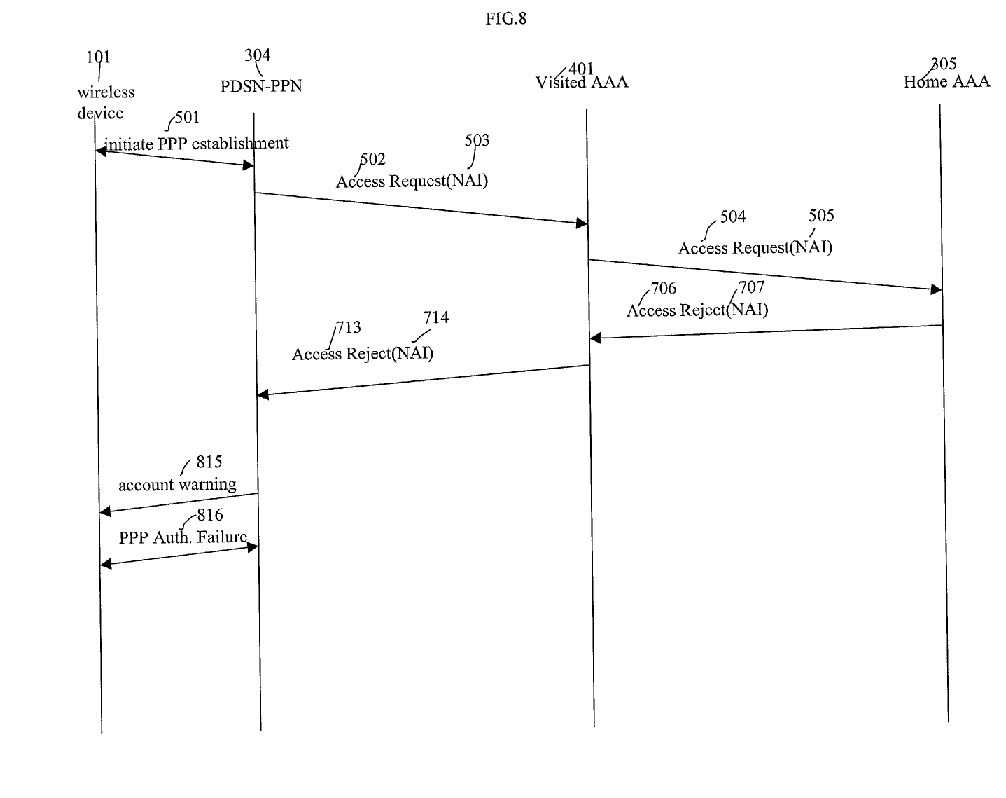

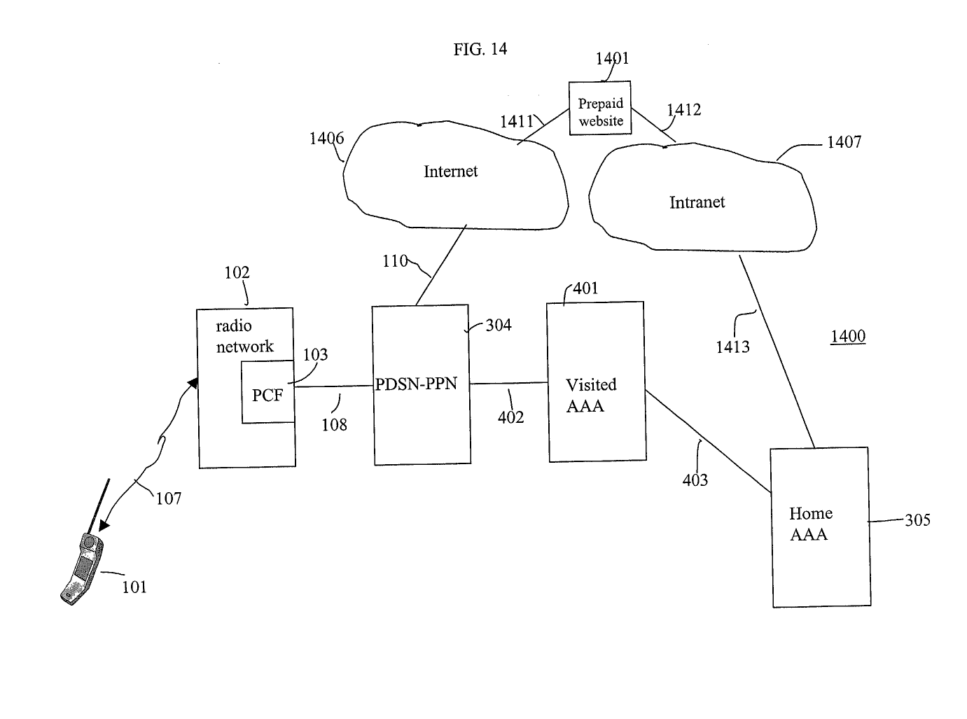

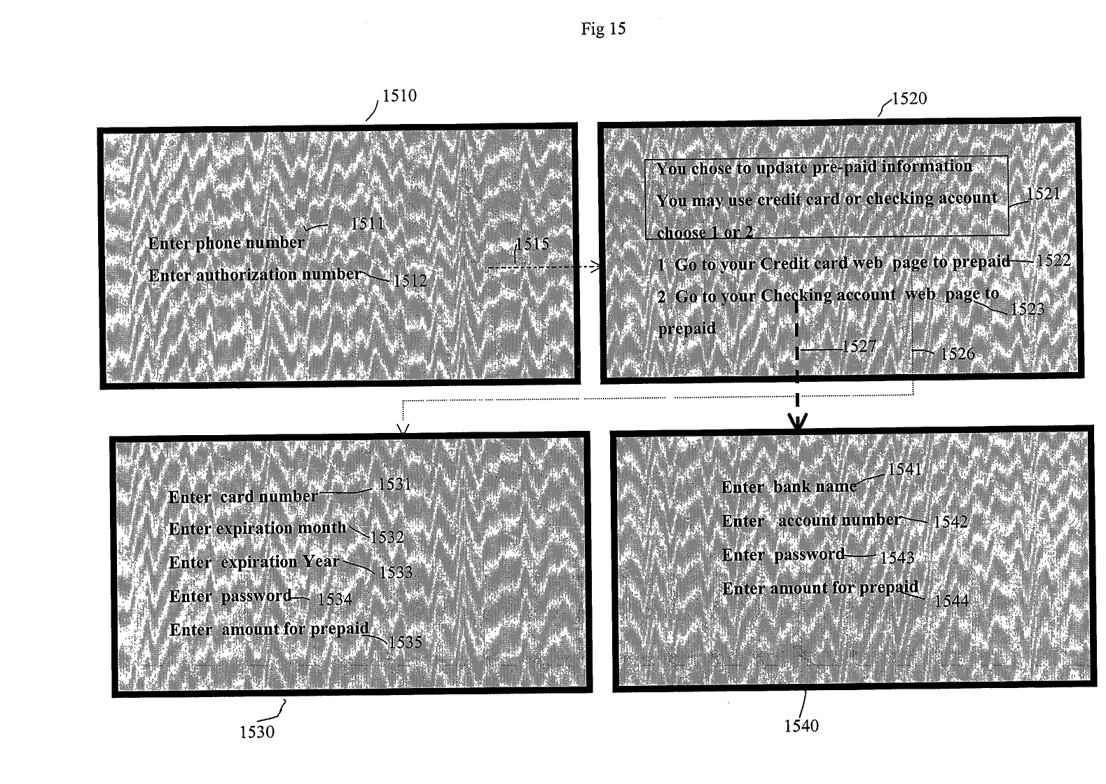

FIG. 8 is a message scenario for an access failure with an associated warning message to wireless device 101 because wireless telecommunications system 400 determines that the balance of the prepaid account is insufficient. Messages 501, 502, 504, 706, and 713 shown in FIG. 7 correspond to messages 501, 502, 504, 706, and 713 shown in FIG. 8. PDSN-PPN 304 sends account warning message 815 to wireless device 101. (The exemplary embodiment uses a parameter in a PPP Authentication-Nak message to transport the account warning). Warning message 815 generates a notification to the subscriber that the subscriber's prepaid account needs to be replenished. If this is the case, the present invention enables the subscriber to replenish the account as described in FIGS. 14 and 15. Once message 815 is received by wireless device 101, PDSN-PPN 304 sends PPP authentication failure message 816, thus ending the call attempt by wireless device 101.

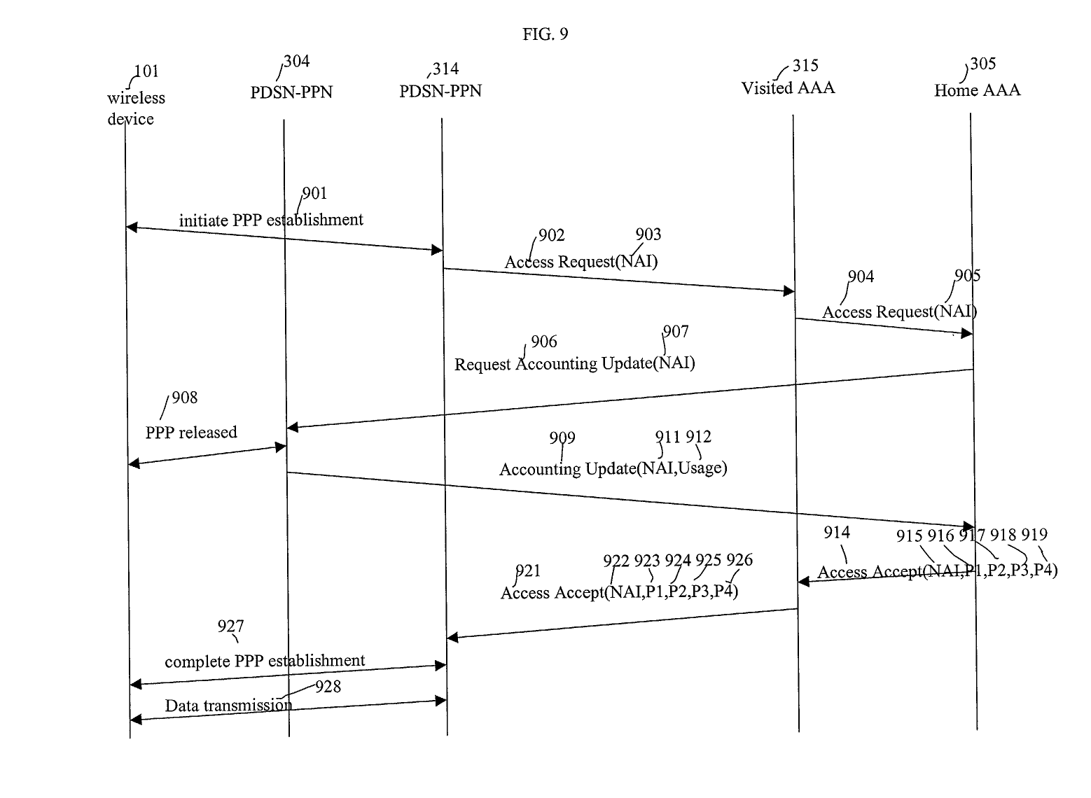

FIG. 9 is a message scenario for a handover in which wireless device 101 is to be served by PDSN-PPN 314 of wireless telecommunications system 400. Radio network 102 and radio network 112 determine that the handover is to be initiated. Consequently, PDSN-PPN 314 initiates PPP establishment 901 with wireless device 101. PSDN-PPN 314 sends access request message 902 with NAI attribute 903 to visited AAA 315. Visited AAA 315 relays access request message 904 with NAI attribute 905 to home AAA 305.

Home AAA 305 determines from NAI attribute 905 that wireless device 101 is currently being served by PDSN-PPN 304. Consequently, home AAA 305 sends request accounting update message 906 with NAI attribute 907 to PDSN-PPN 304 in order to determine the usage associated with the call while wireless device 101 is served by PDSN-PPN 304. In the exemplary embodiment, request accounting update message 906 is implemented with an access-challenge message as specified in IETF RFC 2865. The exemplary embodiment utilizes proprietary attributes to notify PDSN-PPN 304 that the usage associated with wireless device 101 is to be provided in a response message. Consequently, PDSN-PPN 304 returns accounting update message 909 with NAI attribute 911 and usage attribute 912 to home AAA 305. In the exemplary embodiment, accounting update message 909 is implemented as an accounting request message as specified in IETF RFC 2865 and RFC 2866 with proprietary attributes indicating the usage.

Home AAA 305 utilizes usage attribute 912 to adjust the balance of the prepaid account associated with wireless device 101. Home AAA 305 sends access accept message 914 to visited AAA 315. Access accept message 914 comprises attributes that are relevant to prepaid billing, including Acct-Billing-Option (P1) 916, Activation Status (P2) 917, Acct-Usage-Limit (P3) 918, and Acct-Meter-Unit (P4) 919. (Attributes 916, 917, 918, and 919 are discussed in the context of attributes 509, 510, 511, and 512 in FIG. 5.) Acct-Usage-Limit 918 is calculated by home AAA 305 by utilizing the adjusted balance pursuant to the usage indicated by PDSN-PPN 304 in accounting update message 909. With the message scenario shown in FIG. 9, home AAA 305 determines that the adjusted balance is sufficient to continue the call.

Visited AAA 315 relays access accept message 912 with attributes 922, 923, 924, 925, and 926 to PDSN-PPN 314. Attributes 922, 923, 924, 925, and 926 correspond to attributes 915, 916, 917, 918, and 919, respectively. Consequently, PDSN-PPN 314 completes PPP establishment 927 and initiates data transmission 928 to wireless device 101, thus consummating the handover.

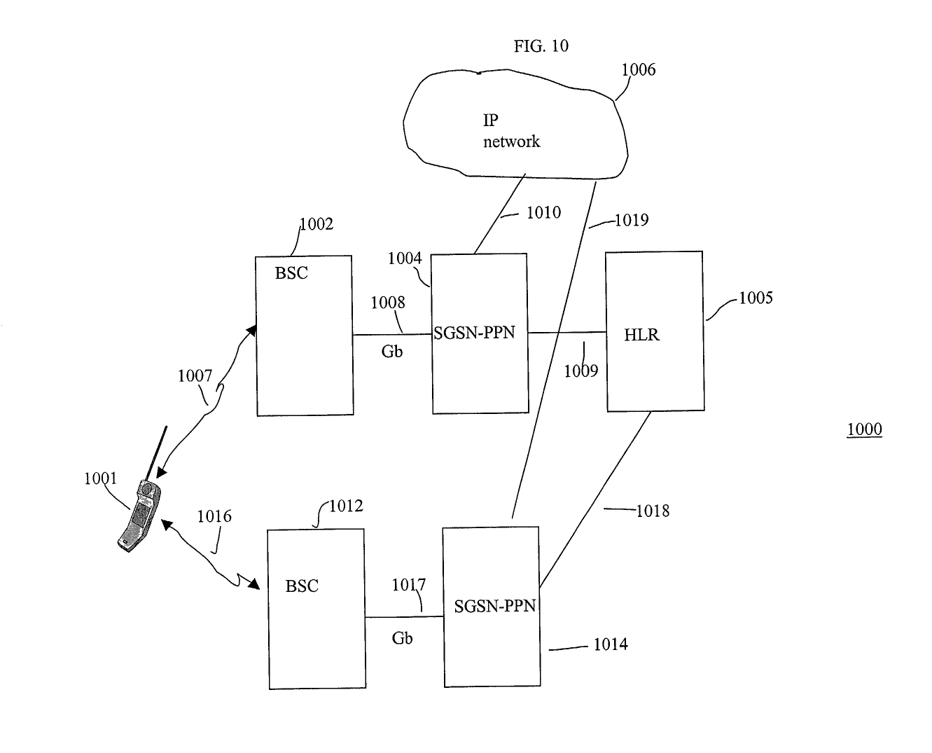

FIG. 10 illustrates either Global System for Mobile Communications (GSM) or Time Division Multiple Access (TDMA) wireless telecommunications system 1000 that supports General Packet Radio Service (GPRS) and that supports prepaid billing of packet data services. A subscriber that is associated with wireless device 1001 can roam from a serving area served by Base Station Controller (BSC) 1002 to a service area served by BSC 1012. Serving GPRS serving node-prepaid packet node (SGSN-PPN) 1004 supports a data connection (e.g. PPP) to wireless device 1001 through radio link 1007, BSC 1002, and Gb interface 1008. Additionally, SGSN-PPN 1004 supervises the usage associated with the call in order to support prepaid billing. In the exemplary embodiment, the SGSN component and the PPN component are co-located on the same platform as SGSN-PPN 1004. SGSN-PPN 1004 completes the call path to IP network 1006 through interface 1010. Thus, the call path comprises radio link 1007, BSC 1002, Gb interface 1008, SGSN-PPN 1004, and interface 1001 to IP network 1006. In the exemplary embodiment, accounting information regarding a prepaid account is provided by home location register (HLR) 1005 to SGSN-PPN 1004 through interface 1009.

If wireless device 1001 moves to the service area served by BSC 1012, a call path is established comprising radio link 1016, BSC 1012, Gb interface 1017, SGSN-PPN 1014, and interface 1019 to IP network 1006. SGSN-PPN 1014 obtains prepaid accounting information from HLR 1005 through interface 1018.

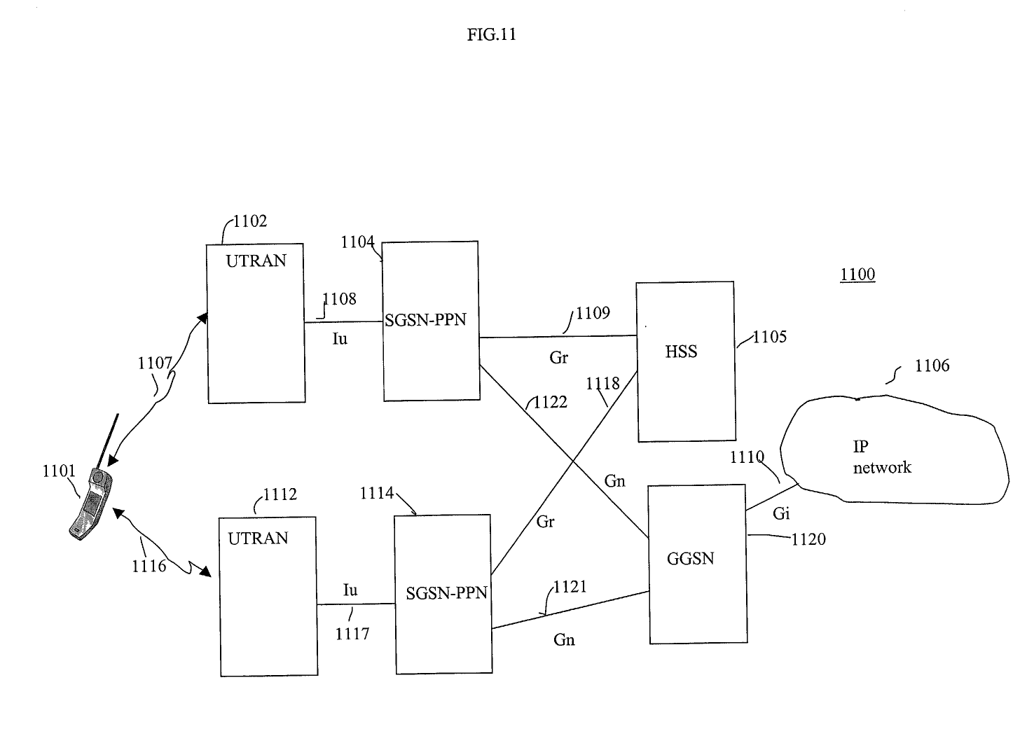

FIG. 11 illustrates universal mobile telecommunications system (UMTS) wireless telecommunications system 1100 that supports prepaid billing of packet data services for a subscriber. In the exemplary embodiment, UMTS wireless telecommunications system 1100 has an architecture in accordance with 3GPP TR 23.821v1.0.1 (3^{rd} Generation Partnership Project; Technical Specification Group Services and System Aspects; Architecture Principles for Release 2000). Wireless device 1101 can roam from a service area served by UMTS terrestrial radio access network (UTRAN) 1102 to a service area served by UTRAN 1112. Serving GPRS serving node-prepaid packet node SGSN-PPN 1104 supports a data connection (e.g. PPP) to wireless device 1101 through radio link 1107, UTRAN 1102, and Iu interface 1108. Additionally, SGSN-PPN 1104 supervises the usage that is associated with the call in order to support prepaid billing. In the exemplary embodiment, the SGSN component and the PPN component are co-located on the same platform as SGSN-PPN 1104. SGSN-PPN 1104 completes the call path to IP network 1106 through Gn interface 1122, Gateway GPRS Service Node (GGSN) 1120, and Gi interface 1110. Thus, the call path comprises radio link 1107, UTRAN 1102, Iu interface 1108, SGSN-PPN 1104, Gn interface 1122, GGSN 1120, and Gi interface 1110 to IP network 1106. In the exemplary embodiment, accounting information regarding a prepaid account is provided by home subscriber server (HSS) 1105 to SGSN-PPN 1104 through Gr interface 1109.

If wireless device 1101 moves to the service area supported by UTRAN 1112, a call path is established comprising radio link 1116, UTRAN 1112, Iu interface 1117, SGSN-PPN 114, Gn interface 1121, GGSN 1120, and Gi interface 1110 to IP network 1106. SGSN-PPN 1114 obtains prepaid accounting information from HSS 1105 through Gr interface 1118.

Table 1 (Mapping of Prepaid Billing Functions with Different Wireless Technologies) summarizes a mapping of prepaid functions to corresponding entities for exemplary configurations shown in FIGS. 3, 4, 10, and 11. FIGS. 3 and 4 illustrate CDMA technology; FIG. 10 illustrates GSM and TDMA technologies; and FIG. 11 illustrates UMTS technology. Additionally, the present invention is applicable to other wireless technologies such as Cellular Digital Packet Data (CDPD) wireless technology. The intent of Table 1 is to present an exemplary mapping for some of the wireless technologies, although one skilled in the art appreciates that other mappings may be possible.

TABLE 1
Mapping of Prepaid Billing Functions with
Different Wireless Technologies

| | Wireless Packet Serving | |
|---|---|---|
| Technology | Node (WPSN) | Accounting Processor |
| CDMA | PDSN | AAA |
| GSM | GGSN or SGSN or IGSN | HLR or AAA |
| UMTS | GGSN or SGSN or IGSN | HSS or HLR or AAA |
| TDMA | SGSN or GGSN or IGSN | AAA or HLR |
| CDPD | MD-IS | Administrative Server |

A function designated “wireless packet serving node-prepaid packet node” (WPSN-PPN) corresponds to monitoring a prepaid packet switched call in accordance with a subscriber's prepaid billing characteristics. The WPSN-PPN monitors the usage during the call and ascertains that the usage does not exceed a maximum limit. If the usage exceeds the maximum limit, the call can be ended. Table 1 illustrates some of the possible mappings of the WPSN to an entity of the associated wireless technology. For example with UMTS, the WPSN may reside at a SGSN, GGSN, or integrated GPRS serving node (IGSN). The IGSN is an integrated version of the SGSN and the GGSN. With CDPD, the WPSN corresponds to a Mobile Data Intermediate System (MD-IS).

A function designated “accounting processor” utilizes information regarding usage, as determined by the WPSN-PPN, and updates the prepaid account of the subscriber. If the balance of the prepaid account is not sufficient whenever the packet switched call is being established, the accounting processor instructs the WPSN to reject the call request. Table 1 illustrates some of the possible mappings of an accounting processor to an entity of the associated wireless technology. For example with UMTS, the accounting processor may reside at the home subscriber server (HSS), home location register (HLR), or AAA. With a prepaid configuration utilizing a HLR or HSS, a protocol such as GSM-MAP may be used for messaging between the HLR or the HSS and the SGSN. With CDPD, the accounting processor may reside on the administrator server.

Wireless devices 101, 1001, and 1101 may be capable of supporting a plurality of wireless technologies, e.g. both CDMA and UMTS. Supporting a plurality of wireless technologies facilitates service continuity when the subscriber is roaming. The accounting processor may adjust the subscriber's prepaid account according to the wireless technology that is utilized by the wireless device.

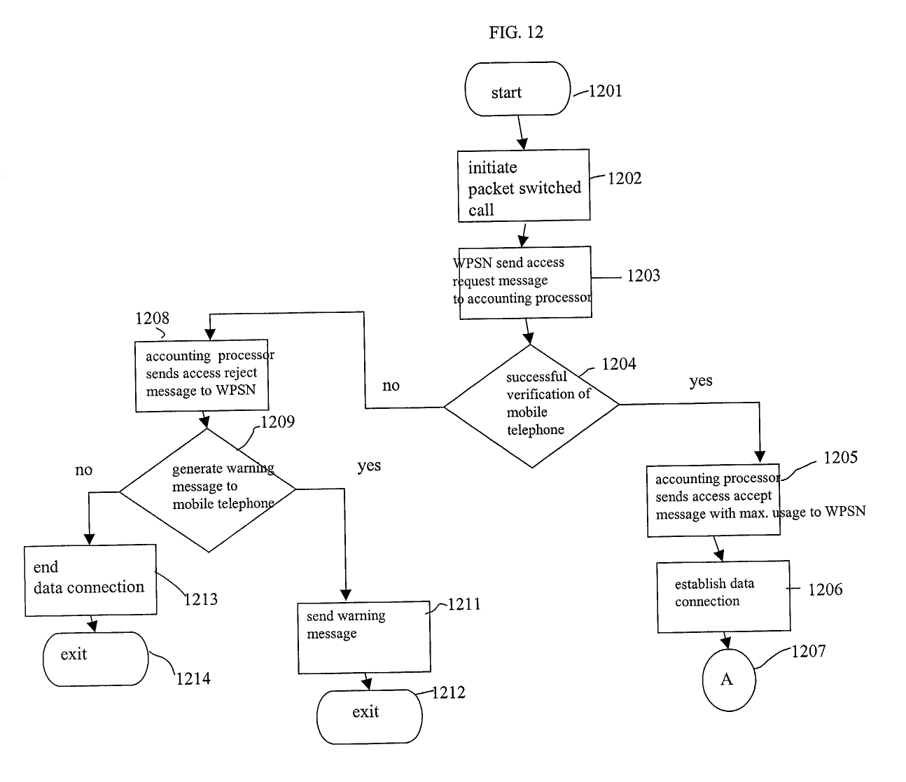

FIG. 12 is a flow diagram form initiating (“call set-up”) of a packet switched call in which a subscriber has a prepaid account for a wireless telecommunications system as shown in FIGS. 3, 4, 10, and 11. Step 1201 starts the set-up procedure. In step 1202 the wireless device (e.g. 101, 1001, or 1101) initiates a packet switched call to radio network 102, BSC 102, or UTRAN 1102. Step 1202 corresponds to message 501 in FIG. 5. In step 1203, the WPSN-PPN (e.g. PDSP-PPN 304, SGSN-PPN 1004, or SGSN 1104) sends an access request message to an accounting processor (e.g. home AAA 305, HLR 1005, or HSS 1105). Step 1203 corresponds to message 502 in FIG. 5.

In step 1204, the accounting processor determines whether the wireless device is valid and has a sufficient balance in the associated prepaid account. If not, the accounting processor sends an access reject message to the WPSN-PPN in step 1208. Step 1208 corresponds to message 713 in FIG. 7. In step 1209, the WPSN-PPN determines if a warning message to the wireless device should be generated. Alternatively, the accounting processor can include a corresponding indicator in the access reject message. If step 1209 determines that no warning message is to be sent, as in step 1213, the data connection is ended. Step 1213 corresponds to message 728 in FIG. 7. The procedure is exited in step 1214. If a warning message is to be sent, as determined by step 1209, the WPSN-PPN sends a warning message to the wireless device in step 1211. Step 1211 corresponds to message 815 and message 816 in FIG. 8.

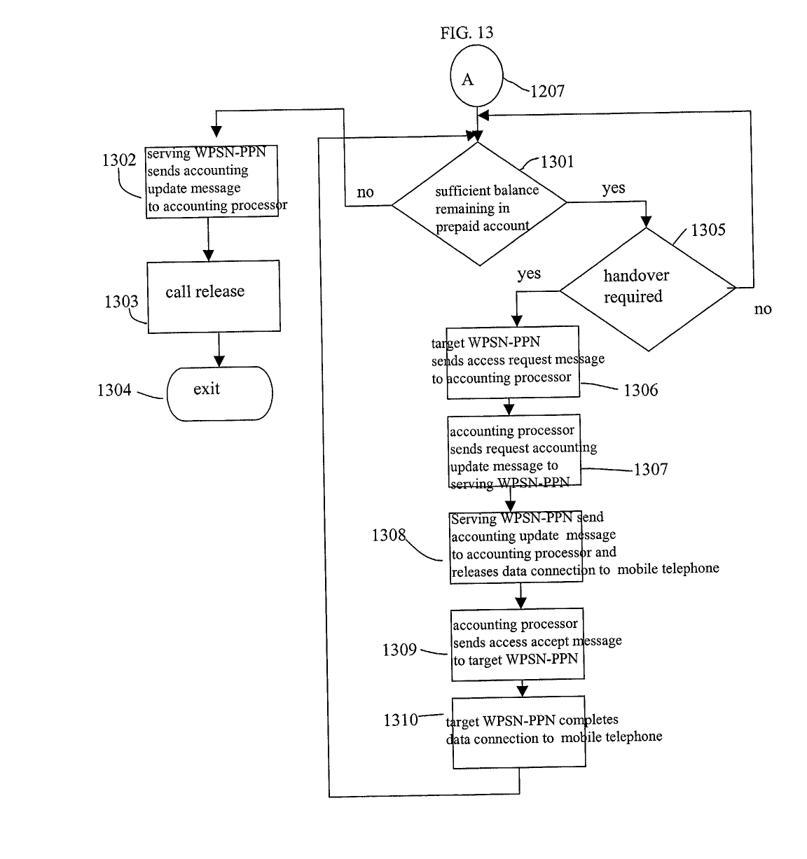

If the wireless device is valid and has a sufficient amount in the associated prepaid account as determined in step 1204, the accounting processor sends an access accept message to the WPSN-PPN in step 1205. Step 1205 corresponds to message 521 in FIG. 5. In step 1206, a data connection is established and the call flow continues as shown in FIG. 13 with step 1207. Step 1206 corresponds to procedure 522 in FIG. 5.

FIG. 13 is a flow diagram form maintaining the packet switched call for the wireless telecommunications system as shown in FIGS. 3, 4, 10, and 11. Step 1207 continues the call processing of the packet switched call. In step 1301, the WPSN-PPN monitors the call and determines if a sufficient balance remains in the subscriber's account based upon the usage and a limit (e.g. Acct-Usage-Limit 511). If there is not a sufficient balance, the serving WPSN-PPN (e.g. PDSN-PPN 304, SGSN-PPN 1004, or SGSN-PPN 1104) sends an accounting update message to the accounting processor in step 1302. Step 1302 corresponds to message 625 in FIG. 6. The call is subsequently released in step 1303. Step 1303 corresponds to procedure 633 in FIG. 6. The call flow is exited in step 1304.

If a sufficient balance remains in the account during the call in step 1301, step 1305 determines if a handover is required by the radio network (e.g. radio network 102, BSC 1002, or UTRAN 1102). The target WPSN-PPN (e.g. PDSN-PPN 314, SGSN-PPN 1014, or SGSN-PPN 1114) sends an access request message to the accounting processor in step 1306. Step 1306 corresponds to message 902 in FIG. 9. In step 1307, the accounting processor sends a request accounting update message to the serving WPSN-PPN. Step 1307 corresponds to message 906 in FIG. 9. With step 1308, the serving WPSN-PPN sends an accounting update message to the accounting processor and releases the data connection to the wireless device. Step 1308 corresponds to message 909 and procedure 908 in FIG. 9.

In step 1309, the accounting processor sends an access accept message to the target WPSN-PPN. Step 1309 corresponds to message 914 in FIG. 9. The target WPSN-PPN completes the data connection to the wireless device in step 1310. Step 1310 corresponds to procedures 927 and 928 in FIG. 9. With the completion of the handover, the target WPSN-PPN becomes the serving WPSN-PPN, and step 1301 is repeated.

FIG. 14 illustrates wireless prepaid system 1400 that enables a subscriber to replenish the subscriber's prepaid account. The subscriber may wish to replenish the prepaid account if the amount is low. Wireless telecommunications systems 300, 400, 1000, and 1100 can support the function of 1400 with a prepaid website (e.g. 1401) and the appropriate connectivity to an Internet network (e.g. 1411), Intranet network (e.g. 1407), and home AAA (e.g. 305).

In FIG. 14, the subscriber connects to prepaid website 1401 by requesting the corresponding website's uniform resource locator (URL e.g. “www.prepaid.TheServiceProvider.com”) through wireless device 101, radio link 107, radio network 102, R-P interface 108, PDSN-PPN 304, interface 110, Internet network 1406, and interface 1411. Prepaid website 1401 provides screens to the subscriber at wireless device 101 as shown in FIG. 15. With the exemplary embodiment, prepaid website 1401 provides the necessary security measures as can be appreciated by one skilled in the art.

After the subscriber completes the prepaid replenishment session by traversing through the screens shown in FIG. 15, prepaid website 1401 updates the subscriber's prepaid account by accessing the subscriber's records that are associated with home AAA 305 through interface 1402, Intranet 1407, and interface 1413.

FIG. 15 shows a set of visual screens that can be displayed at wireless device 101 in order to replenish the subscriber's prepaid account. At the beginning of the session, screen 1510 is displayed. The subscriber enters telephone number 1511 (which alternatively may be the wireless device's identifier such as the network address identifier) and authorization number 1512 that are associated with the prepaid account. Authorization number 1512 functions as a personal identification number, thus providing a degree of security.

Transition 1515 causes screen 1520 to be displayed to the subscriber. Text block 1521 queries the subscriber to choose a method of payment. In the exemplary embodiment, website 1401 supports credit cards and checking accounts. Other forms of payment can be supported by website 1401 such as a prepaid card that can be purchased at a distributor. If the subscriber wishes to pay with a credit card, the subscriber chooses selection 1522. Transition 1526 is then initiated, causing screen 1530 to be displayed to the subscriber. With screen 1530, the subscriber enter credit card information comprising card number 1531, expiration month 1532, expiration year 1533, password 1534, and amount 1535 to be added to the prepaid account.

The exemplary embodiment can be expanded in which the subscriber can choose to have the subscriber's prepaid account to be automatically replenished whenever the amount in the prepaid account is less than a minimum value.

If the subscriber wishes to use a checking account for payment as illustrated in screen 1520, the subscriber chooses selection 1523, causing transition 1527 to be initiated. Screen 1540 is then displayed to the subscriber. The subscriber enters information related to the subscriber's checking account comprising bank name 1541, account number 1542, password 1543, and amount 1544 to be added to the subscriber's prepaid account.

In addition to enabling the subscriber to replenish the subscriber's prepaid account through wireless device 101, wireless prepaid system 1400 can enable the subscriber to access prepaid website 1401 through a communications device, e.g. a personal computer connected through a fixed network, cable device connected to an Internet, or a wireless device) that is not associated with the subscriber's prepaid account.

An alternative embodiment utilizes a telephone processing unit in lieu of a prepaid website for analyzing the subscriber's request for replenishing the subscriber's prepaid account. (In such a case, the subscriber can call a designated telephone number e.g. 800-PRE-PAID.) The telephone processing unit can accept either a speech signal that is articulated by the subscriber or a series of tones that denote the subscriber's selections during the session.

It is to be understood that the above-described embodiment is merely an illustrative principle of the invention and that many variations may be devised by those skilled in the art without departing from the scope of the invention. It is, therefore, intended that such variations be included with the scope of the claims.

What is claimed is:

1. A wireless telecommunications system which provides prepaid charging for a packetized data service comprising:
a first prepaid packet node (PPN);
a first wireless packet serving node (WPSN) logically associated with said first PPN;
means responsive to a subscriber call initiation, for requesting packetized data service via said first PPN through said first WSPN;
means for maintaining a current balance of a prepaid subscriber account;
means for receiving said current balance at said first PPN.

2. The wireless communications system of claim 1, wherein said balance exceeds a first minimum value, and further comprising:
means for completing a first data connection to said wireless device by said first WPSN in response to said means for returning said balance to said first PPN by said accounting processor, said first data connection supporting said packetized data service.

3. The wireless communications system of claim 1, wherein said balance does not exceed a first minimum value, and further comprising:
means for rejecting said initiation of said call by said first WPSN in response to said means for returning said balance to said PPN by said accounting processor.

4. The wireless communications system of claim 1, wherein said balance does not exceed a first minimum value, and further comprising:
means for sending an indication to said wireless device in response to said means for returning said balance to said first PPN by said accounting processor, said indication informing said subscriber to replenish an amount in said prepaid account; and
means for rejecting said initiation of said call by said first WPSN in response to said means for sending said indication to said wireless device.

5. The wireless communications system of claim 2, wherein said balance does not exceed a second minimum value, and further comprising:
means for sending an indication to said wireless device in response to said means for completing said first data connection, said indication informing said subscriber to replenish an amount in said prepaid account.

6. The wireless telecommunications system of claim 2, further comprising:
means for decrementing said balance by said first PPN according to a usage of said packetizied data service;
means for informing said first WPSN by said first PPN whenever said balance is less than a third minimum value; and
means for discontinuing said call by said first WPSN in response to said means for informing by said first PPN.

7. The wireless telecommunications system of claim 2, further comprising:
means for instructing said first PPN through said first WPSN that said call is released by said wireless device in response to said subscriber discontinuing said call;
means for updating said balance by said first PPN in response to said means for instructing said first PPN;
means for sending said balance to said accounting processor by said first PPN in response to said means for updating said balance by said first PPN; and
means for modifying said prepaid account by said accounting processor in response to said means for sending said balance to said accounting processor.

8. The wireless system of claim 2, further comprising:
a second PPN;
a second WPSN logically associated with said second PPN;
means for detecting a handover event by said second PPN through said second WPSN, said handover event generated by said radio network;
means for querying said accounting processor by said second PPN for said balance of said prepaid account in response to said means for detecting said handover event;
means for instructing said first PPN by said accounting processor to update said balance in response to said means for querying said accounting processor by said second PPN;
means for returning said balance to said accounting processor by said first PPN in response to said means for instructing said first PPN;
means for responding with said balance by said accounting processor to said second PPN in response to said means for returning said balance to said accounting processor by said first PPN; and
means for completing a second data connection to said wireless device by said second WPSN through said second PPN in response to said means for responding with said balance to said second PPN.

9. The telecommunications system of claim 1, wherein said means for calculating said balance by said accounting processor comprises:
means for retrieving an amount in said prepaid account by said accounting processor;
means for retrieving a rate by said accounting processor; and
means for determining said balance from said rate and said amount.

10. The telecommunications system of claim 9, wherein said rate is dependent upon at least one variable selected from the group consisting of a time of day, a day of week, a subscriber's calling plan, a service location of said wireless device, and a subscriber's level of quality of service (QoS).

11. The telecommunications system of claim 1, wherein said wireless device is selected from the group consisting of a mobile wireless terminal and a fixed wireless terminal.

12. The wireless telecommunications system of claim 1, wherein said wireless device supports at least one wireless technology and wherein said accounting processor adjusts said subscriber's prepaid account according to a wireless technology utilized by said wireless device.

13. The wireless telecommunications system of claim 1, wherein said call utilizes voice over Internet Protocol (VoIP).

14. The wireless telecommunications system of claim 1, wherein said balance indicates said limited usage selected from the group consisting of a number of packets, a time duration of said call, a time duration of active transmission, and an amount of transferred information.

15. The wireless telecommunication system of claim 1, wherein said wireless device supports Code Division Multiple Access (CDMA).

16. The wireless telecommunications system of claim 1, wherein said wireless device supports Global System for Mobile Communications (GSM).

17. The wireless telecommunications system of claim 1, wherein said wireless device supports Universal Mobile Telecommunications System (UMTS).

18. The wireless telecommunications system of claim 1, wherein said wireless device supports Time Division Multiple Access (TDMA).

19. The wireless telecommunications system of claim 1, wherein said wireless device supports Cellular Digital Packet Data (CDPD).

20. A wireless telecommunications system enabling a subscriber of a wireless device to replenish an amount of a prepaid account, said prepaid account associated with a packetized service, said wireless telecommunications system communicating to said wireless device through a radio network, said wireless telecommunications system comprising:
a signal processor;
an accounting processor connected to said signal processor through a communications network;
a communications device connected to said signal processor through said communications network;
means for requesting a replenishment of said amount to said signal processor by said subscriber through said communications device; and
means for conveying said replenishment of said amount to said accounting processor by said signal processor in response to said means for requesting said replenishment of said amount by said subscriber.

21. The wireless telecommunications system of claim 20, wherein said signal processor comprises a website and wherein said communications network comprises a IP network.

22. The wireless telecommunications system of claim 20, wherein said signal processor comprises a telephone processing unit and wherein said communications network comprises a telephone network.

23. The wireless telecommunications system of claim 20, wherein said communications device comprises said wireless device.

24. A method for providing prepaid charging for a call by a wireless telecommunications system, said call associated with a packetized data service, said packetized data service associated with a wireless device of a subscriber, said wireless communications system communicating to said wireless device through a radio network, said wireless telecommunications system comprising the steps of:
requesting a first prepaid packet node (PPN) through said a first wireless packet serving node (WPSN) for said packetized data service by said wireless device responsive to said subscriber's initiation of said call;
querying an accounting processor by said first PPN for a balance of a prepaid account of said subscriber responsive to said step of requesting said packetized data service;
calculating said balance by said accounting processor responsive to said step of querying said accounting processor; and
returning said balance to said first PPN by said accounting processor responsive to said step of calculating by said accounting processor.

25. The method of claim 24, wherein said balance exceeds a first minimum value, and further comprising the step of:
completing a first data connection to said wireless device by said first WPSN responsive to said step of returning said balance to said first PPN by said accounting processor, said first data connection providing said packetized data service.

26. The method of claim 24, wherein said balance does not exceed a first minimum value, and further comprising the step of:
rejecting said initiation of said call by said first WPSN responsive to said step of returning said balance to said PPN by said accounting processor.

27. The method of claim 24, wherein said balance does not exceed a first minimum value, and further comprising the steps of:
sending an indication to said wireless device responsive to said step of returning said balance to said first PPN by said accounting processor completing, said indication informing said subscriber to replenish an amount in said prepaid account; and
rejecting said initiation of said call by said first WPSN responsive to said step of sending said indication to said wireless device.

28. The method of claim 25, wherein said balance does not exceed a second minimum value, and further comprising the step of:
sending an indication to said wireless device responsive to said step of completing said first data connection, said indication informing said subscriber to replenish an amount in said prepaid account.

29. The method of claim 24, further comprising the steps of:
decrementing said balance by said first PPN according to a usage of said packetizied data service;
informing said first WPSN by said first PPN whenever said balance is less than a third minimum value; and
discontinuing said call by said first WPSN responsive to said step of informing by said first PPN.

30. The method of claim 24, further comprising the steps of:
instructing said first PPN through said first WPSN that said call is released by said wireless device responsive to said subscriber discontinuing said call;
updating said balance by said first PPN responsive to said step of instructing said first PPN;
sending said balance to said accounting processor by said first PPN responsive to said step of updating said balance; and
modifying said prepaid account by said accounting processor responsive to said step of sending said balance to said accounting processor.

31. The method of claim 24, further comprising the steps of:
detecting a handover event by a second PPN through a second WPSN, said handover event generated by said radio network;
querying said accounting processor by said second PPN for said balance of said prepaid account responsive to said step of detecting said handover event;
instructing said first PPN by said accounting processor to update said balance responsive to said step of querying said accounting processor by said second PPN;
returning said balance to said accounting processor by said first PPN responsive to said step of instructing said first PPN by said accounting processor;
responding with said balance by said accounting processor to said second PPN responsive to said step of returning said balance to said accounting processor by said first PPN; and
completing a second data connection to said wireless device by said second WPSN through said second PPN responsive to said step of responding with said balance to said second PPN.

32. The method of claim 24, wherein said step of calculating said balance by said accounting processor comprises:
retrieving an amount in said prepaid account by said accounting processor;
retrieving a rate by said accounting processor; and
determining said balance from said rate and said amount.

33. A method enabling a subscriber of a wireless device to replenish an amount of a prepaid account associated with a wireless telecommunications system, said prepaid account associated with a packetized service, said wireless telecommunications system communicating to said wireless device through a radio network, said wireless telecommunications system comprising:
requesting a replenishment of said amount to a signal processor by said subscriber; and
conveying said replenishment of said amount to an accounting processor by said signal processor responsive to said step of requesting said replenishment of said amount by said subscriber.

34. An accounting processor providing prepaid charging for a call in conjunction with a wireless telecommunications system, said call associated with a packetized data service for a subscriber, said wireless telecommunications system comprising a first prepaid packet node (PPN) and a second PPN, said accounting processor comprising:
means for calculating a balance for said call from a prepaid account of said subscriber in response to said first PPN querying said accounting processor for said balance; and
means for returning said balance to said first PPN in response to said means for calculating said balance by said accounting processor.

35. The accounting processor of claim 34, further comprising:
means for modifying said prepaid account in response to said first PPN sending an updated balance to said accounting processor, said updated balance indicative of a usage associated with said call.

36. The accounting processor of claim 34, further comprising:
means for instructing said first PPN to update said balance in response to said accounting processor being notified of a handover event by said second PPN: and means for sending said balance to second PPN in response to receiving said balance from said first PPN.

37. A method for supporting prepaid charging for a call by an accounting processor in conjunction with a wireless telecommunications system, said call associated with a packetized data service for a subscriber, said wireless telecommunications system comprising a first prepaid packet node (PPN) and a second PPN, said method comprising the steps:
calculating a balance for said call from a prepaid account of said subscriber responsive to said first PPN querying said accounting processor for said balance; and
returning said balance to said first PPN responsive to said step of calculating said balance by said accounting processor.

38. The method of claim 34, further comprising the step of:
modifying said prepaid account responsive to said first PPN sending an updated balance to said accounting processor, said updated balance indicative of a usage associated with said call.

39. The method of claim 34, further comprising the steps of:
instructing said first PPN to update said balance responsive to said accounting processor being notified of a handover event by said second PPN: and
sending said balance to second PPN responsive to receiving said balance from said first PPN.
